(19) United States
(12) Patent Application Publication
(10) Pub. No.: US 2014/0159487 A1
(43) Pub. Date: Jun. 12, 2014

(54) Energy-saving central control system and energy-saving lighting device comprised thereof

(71) Applicant: Jhen Ye International CO., LTD, Kaohsiung (TW)

(72) Inventor: Chuan-An Han, Kaohsiung (TW)

(73) Assignee: Jhen Ye International CO., LTD, Kaohsiung (TW)

(21) Appl. No.: 14/178,304

(22) Filed: Feb. 12, 2014

(51) Int. Cl. H02J 4/00

(52) U.S. Cl. CPC H02J 4/00
USPC 307/31

(57) ABSTRACT

An energy-saving central control system and energy-saving lighting devices comprised thereof is provided. The invention stores power produced from retail electricity during off-peak hours and electricity generated by renewable energy sources, and controls the electricity output by means of control equipments. The control equipment has an energy-saving central control system. The energy-saving central control system includes a control module, a management module, a cloud transmission module, and a warning module that are electrically connected to one another. Accordingly, when an electrical appliance is electrically connected to system, the electrical appliance can be turned on or off, and can be monitored for its condition of electricity consumption and usage condition.

### BACKGROUND OF THE INVENTION

1. Field of the Invention

The invention relates to an energy-saving equipment and more particularly to an energy-saving central control system and energy-saving lighting devices comprised thereof which can store power produced from retail electricity during off-peak hours and electricity generated by renewable energy sources; provide stored electricity for consumption during peak hours; and effectively manage electrical energy output and usage condition of electrical appliances.

2. Description of Related Art

Currently, the retail electricity is generated by means of hydroelectric power, solar power, wind power, thermal power and nuclear power generation. Among them, nuclear power only accounts for 24 percent of power consumed by humans worldwide. Currently, there will be more and more nuclear power plants to be constructed due to the insufficient power supply. However, the main reason of power shortage is because the perspective of most people only focuses on using the electrical energy and ignores how to store the electrical energy, resulting in unnecessary waste of the available electrical energy.

As living standards improve and science and technology advance, the natural environment has suffered serious damages. Therefore, green energy technologies and the awareness of energy-saving have been gradually growing, while the common energy-saving approaches previously known can be implemented by using energy-efficient light bulbs (for example, energy-saving light bulbs, LED (light-emitting diode) lighting appliances) and turning off the lights in order to save power.

However, living in today's fast paced society makes mankind easily neglect to conserve electricity, such as turning the computer on for a long period of time or leaving in a hurry without switching the light off. Before realizing what happens, energy has already been wasted for a substantial period of time. The situation is likely to occur when there is no centralized management on the control ends of the electrical appliances for monitoring of electricity consumption. Therefore, if the control ends of the electrical appliances are under centralized management and, meanwhile, their electricity consumption is monitored, consumers can conveniently manage the on and off operations of electrical appliances. At the same time, consumers are able to monitor the electricity consumption of the electrical appliances, thus to effectively master the usage of electricity and to achieve the goal of energy savings.

Accordingly, based on years of experience in research and developments in relevant areas, inventors of the invention studied the aforementioned unfavorable shortage of energy savings and actively sought for solutions of aforementioned needs. After a long period of development and numerous tests, the invention is completed.

### SUMMARY OF THE INVENTION

The main objective of the invention is to store power produced from retail electricity during off-peak hours and electricity generated by renewable energy sources, and to provide stored electricity for consumption during peak hours by means of control equipments in most effective and energy-saving ways. In addition, through the internet connection, usage conditions of electrical appliances can be managed to reduce unnecessary energy waste.

The secondary objective of the invention is an energy-saving lighting device suitable for the Energy-saving central control system. The power input port of the energy-saving lighting device is electrically connected to the control equipment, which helps the energy-saving lighting device to achieve the effect of energy-saving and to be maintained and repaired more conveniently.

According to aforementioned objectives, the invention presents an energy-saving central control system and energy-saving lighting device comprised thereof, whereas the energy-saving central control system functions within a control equipment and the control equipment is electrically connected to an electrical energy storage device. The energy-saving central control system comprises a control module, a management module, a cloud transmission module and a warning module that are electrically connected to one another. The control module comprises a lighting unit, an air conditioning unit, an appliance unit, a water heating unit and a power monitoring unit. The power monitoring unit is electrically connected to the lighting unit, the air conditioning unit, the appliance unit and the water heating unit, in order to monitor the usage condition of the control equipment, the electrical energy storage device and the electrical appliance.

The energy-saving lighting device is equipped with a power input port connected to the lighting unit, which provides 12 volts to 60 volts of electricity.

The electrical energy storage device is used to store power produced from retail electricity and electricity generated by renewable energy sources.

The aforementioned management module is for the management of the input and output amount of electricity, management of the input or output time of electricity, and the monetary value of electricity output.

When the electrical appliance is damaged, consumes electricity during the time while not being used, or has a monetary value of consumed electricity exceeding a specified range, the power monitoring unit then instantly triggers the warning module to produce warning signals or to issue warning signals to be transmitted through the cloud transmission module to smartphone type of communication devices or multimedia devices.

The energy-saving central control system also includes a money transaction module whereas the money transaction module has a payment mechanism to transmit the payment message through the cloud transmission module to the user's smartphone type of communication devices or multimedia devices, allowing the user to submit payments through the money transaction module.

The money transaction module also includes a leasing unit whereas the leasing unit is electrically connected to the energy-saving central control system for the convenience of recording statistical data of leasing cost when the energy-saving central control system is leased to users.

Accordingly, when the administrator leases the control equipment and the electrical energy storage device to the user and the control equipment and the electrical energy storage device are installed in user's home, the electrical energy storage device stores electricity during off-peak hours and provides stored electricity for consumption during peak hours. When the electrical appliance is used during off-peak hours, the energy-saving central control system will switch to utilize the retail electricity, while the electrical energy storage device continues to store electricity during off-peak hours. Using the control equipment to manage the electricity output of the electrical energy storage device and changing the electrical appliances at home to the electrical appliances suitable to be electrically connected to the lighting unit, the air conditioning unit, the appliance unit, the water heating unit and the power monitoring unit in the energy-saving central control system, such as energy-saving lighting devices. Each power input port of the energy-saving lighting device is electrically connected to the lighting unit of the control module, so that the on and off operations of every energy-saving lighting device is centralized and controlled by the lighting unit. The setting achieves the goal of having a control end to manage the on and off operations of a plurality of lighting devices, which differs from the conventional mode of operation using one power control end for managing the on and off of one lighting device. The electricity output and electricity output time is managed by means of the control module and the duration of electricity consumption and monetary value are recorded as well. When the power monitoring unit detects energy waste from the energy-saving lighting device of due to damages, the power monitoring unit will instantly triggers the warning module to produce warning signals to alert the administrator or the user, or to issue warning signals to be transmitted through the cloud transmission module to smartphone type of communication devices or multimedia devices, clearly informing the administrator or the user that the energy-saving device needs repair. Since the power input port of the energy-saving lighting device is electrically connected to the lighting unit, maintenance or repair only needs to be done on the lighting unit. In addition, the power monitoring unit also contains the information of usage condition of all the electrical appliances, which are electrically connected to the energy-saving central control system, and thus allows maintenances possibly to be conducted before damage to electrical appliances occurs. When it is time to submit the electricity payment, the management module in the control equipment issues a billing message, transmitted through the cloud transmission module, to user's smartphone type of communication devices or multimedia devices. Users can submit payments through the money transaction module, thus to improve the convenience of payment submission.

The above and other objects, features and advantages of the invention will become apparent from the following detailed description taken with the accompanying drawings.

### BRIEF DESCRIPTION OF THE DRAWINGS

FIG. 1 is a schematic diagram of the energy-saving equipment;

FIG. 2A is a schematic diagram of the energy-saving central control system;

FIG. 2B is a flow chart of the warning signal; and

FIG. 3 is a schematic diagram of an embodiment of the invention.

### DETAILED DESCRIPTION OF THE INVENTION

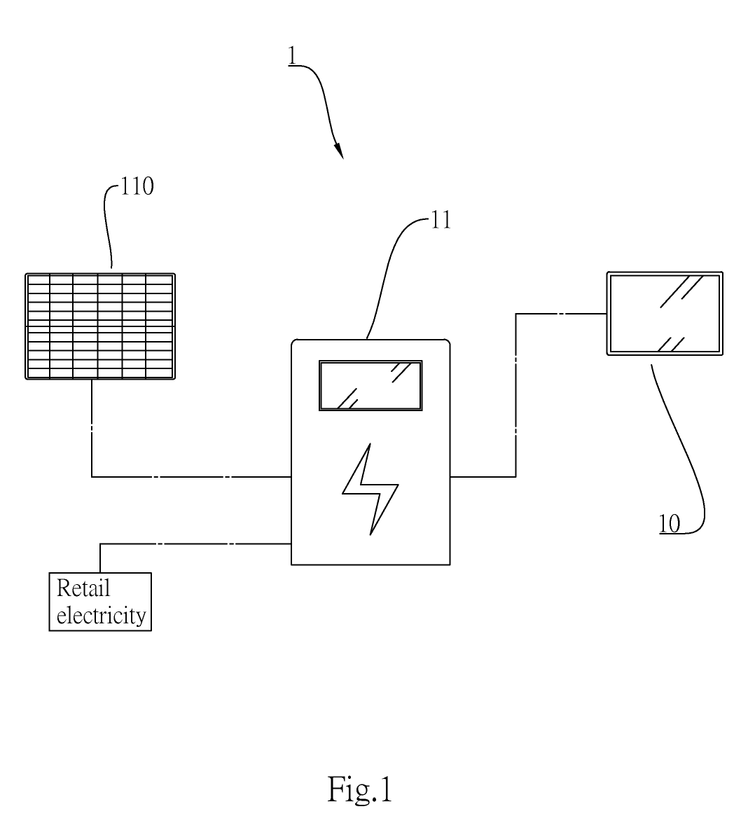

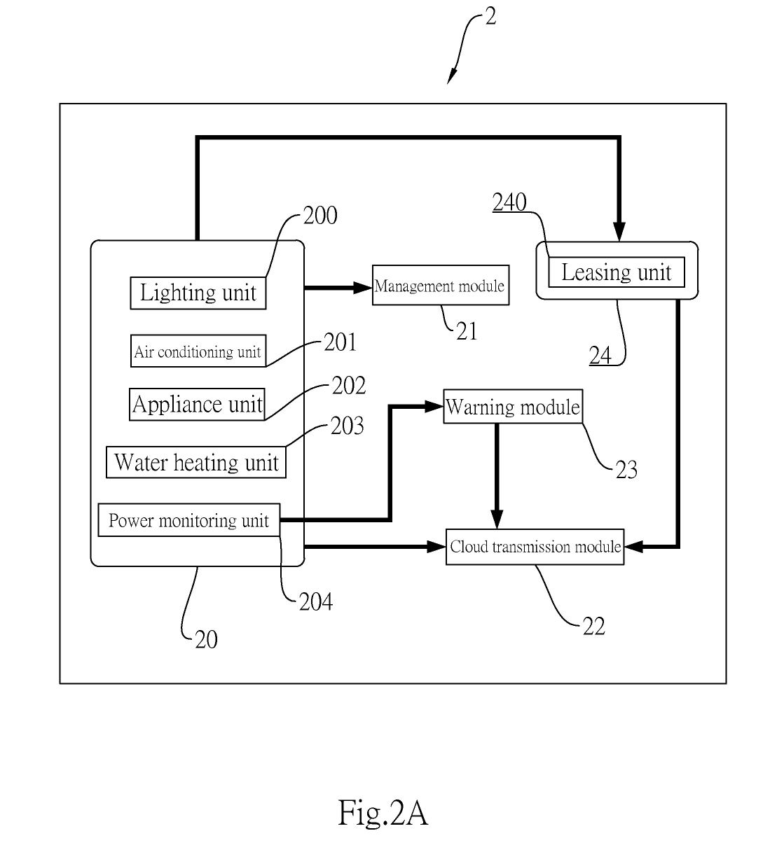

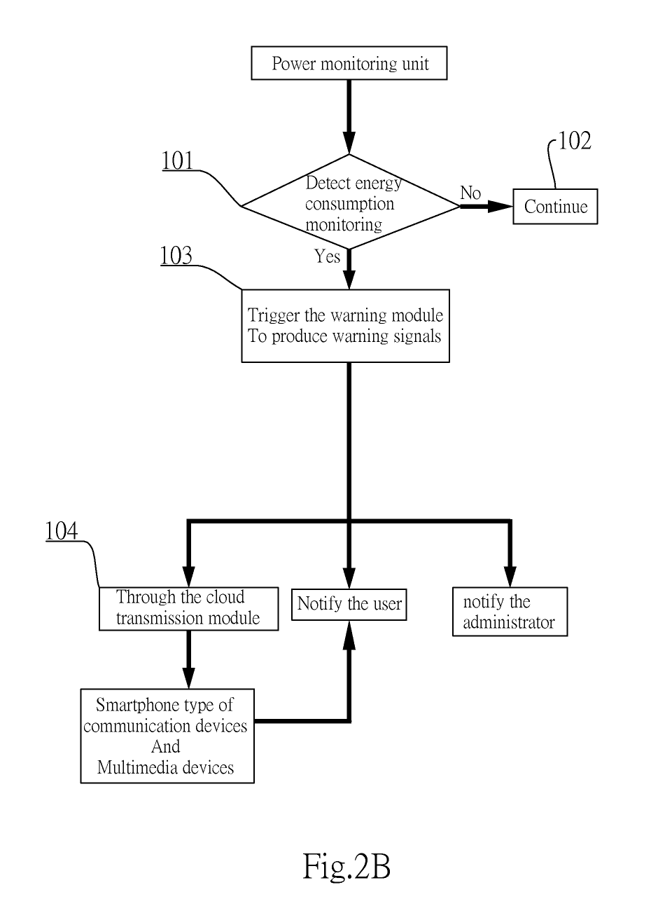

Referring to FIG. 1, FIG. 2A and FIG. 2B, an energy-saving central control system 2 of the invention functions within a control equipment 1. The control equipment 1 comprises an electrical energy storage device 11 and a control equipment 10 for the energy-saving central control system 2 to conduct operations. The electrical energy storage device 11 is connected to a solar panel 110 to mainly store power produced from retail electricity during off-peak hours or electricity generated by renewable energy sources (the solar panel 110 being used as the example in the figure) and to provide stored electricity during peak hours, whereas the electrical energy storage device 11 is electrically connected to the control equipment 10. The energy-saving central control system 2 is electrically connected to a control module 20, a management module 21, a cloud transmission module 22, a warning module 23 and a money transaction module 24.

The control module 20 includes a lighting unit 200, an air conditioning unit 201, an appliance unit 202, a water heating unit 203, and a power monitoring unit 204, whereas the lighting unit 200 can control the on and off operations of lighting equipments; the air conditioning unit 201 can control the on and off operations of air conditioning equipments; the appliance unit 202 can control the on and off operations of electrical appliances, such as the television, refrigerator, and washing machine; the water heating unit 203 can control the on and off heating operations of water heating devices; and the power monitoring unit 204 is mainly to monitor whether the electrical appliance is damaged or is consuming electricity while not being in use, the usage condition of electrical appliances which are electrically connected to the energy-saving central control system 2, the amount of stored power in the electrical energy storage device 11, whereas when the amount of stored power in the electrical energy storage device 11 is less than 20% (with adjustable settings according to the requirements), the electrical appliance is switched to use retail electricity in order to avoid depletion of stored power in the electrical energy storage device 11; when an unexpected condition occurs (such as power outage), the electrical energy storage device 11 will provide the remaining stored power from off-peak hours to crucial electrical appliances (such as the energy-saving lighting device 3).

The management module 21 manages the amount of stored electricity, the output amount of electricity, and the output time of electricity within the electrical energy storage device 11, and records the monetary value and time of electricity consumption by the electrical appliances.

The cloud transmission module 22 provides the connection to the internet, in conjunction with smartphone type of communication devices or multimedia equipments to remotely control the control equipment 10 and to manage the usage of electricity of electrical appliances.

In regard to the warning module 23 (with reference to FIG. 2B), when none of the following condition is detected by the power monitoring unit 204, such that the electrical appliance is damaged and consumes electricity; the electrical appliance consumes electricity during the time of not being used; or power overload results in additional monetary expenses (i.e. process 101), the power monitoring unit 204 will continue the monitoring process (i.e. process 102), or when the above conditions are detected, the power monitoring unit 204 will trigger the warning module 23 to send warning signals (i.e. process 103) to the user and the administrator, or to send warning signals through the cloud transmission module 22 to smartphone type of communication devices or multimedia equipments (i.e. process 104); and the money transaction module 24 has a payment mechanism to transmit the payment message through the cloud transmission module 22 to the user's smartphone type of communication device or multimedia device, allowing the user to submit payments through the money transaction module 24; the money transaction module 24 also has a leasing unit 240 for the convenience of recording statistical data of leasing cost when the energy-saving equipment 1 is leased to users.

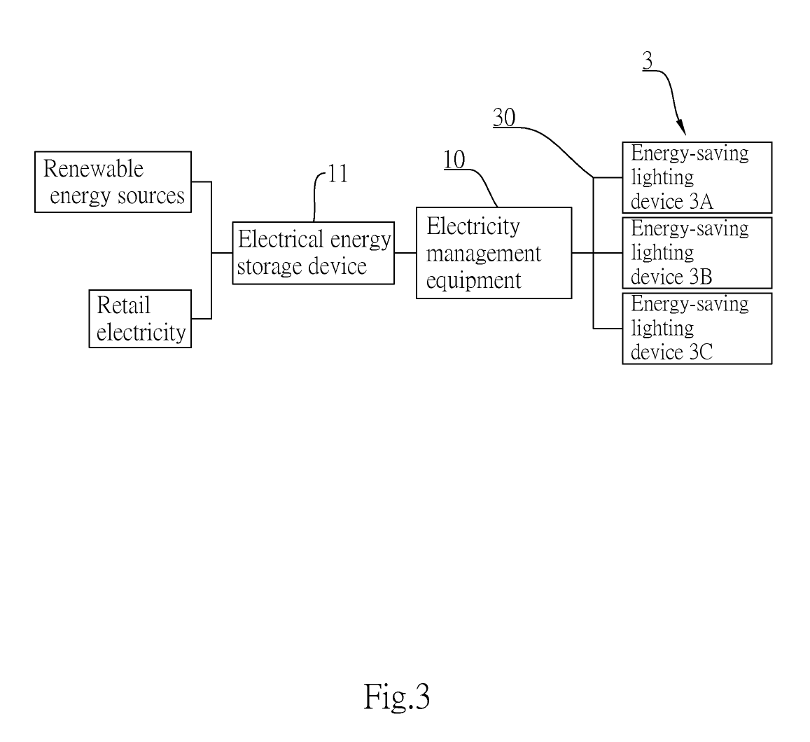

Referring to FIG. 3 in conjunction with FIG. 1 and FIG. 2A, the invention uses the energy-saving lighting device 3A, the energy-saving lighting device 3B, and the energy-saving lighting device 3C as examples, but not limited to the quantity of the energy-saving lighting device 3 described thereof. In regard to the type of energy-saving lighting devices suitable for the energy-saving central control system 2, the power input ports 30 of the energy-saving lighting device 3A, the energy-saving lighting device 3B, and the energy-saving lighting device 3C are electrically connected to the lighting unit 200 of the control equipment 10 so that the energy-saving lighting device 3A, the energy-saving lighting device 3B, and the energy-saving lighting device 3C are centralized and controlled by the lighting unit 200 of on and off operations, in order to achieve the goal of having a control end to manage the on and off operations of a plurality of lighting devices (as illustrated in FIG. 3), which differs from the conventional mode of operation using one power control end for managing the on and off of one lighting device. The energy-saving lighting device only requires 12 volts to 60 volts of electricity. In addition, the energy-saving lighting device 3 has the feature of longer usage life time than that of a LED light bulb. Since the power input port 30 is electrically connected to the lighting unit 200, when the power monitoring unit 204 detects that the energy-saving lighting device 3 is damaged and consumes electricity, the power monitoring unit 204 will trigger the warning module 23 to produce warning signals. Besides, the power input port of the energy-saving lighting device 3 is electrically connected to the lighting unit 200 of the energy-saving central control system 2, maintenance or repair only needs to be done on the lighting unit 200. In order to support energy savings and carbon reduction and to avoid unnecessary waste of energy, the time to supply electricity to residents is divided into two intervals, namely peak hours and off-peak hours, supplied with different amount of power and rates. When the administrator leases the energy-saving equipment 1 to the user and installs the energy-saving equipment 1 in user's home, the electrical energy storage device 11 stores electricity received during off-peak hours or generated by the solar panel 110, and provides stored electricity for consumption during peak hours. Therefore, the retail electricity is utilized most effectively and, indirectly, the expense is significantly reduced.

When the electrical appliance is used during off-peak hours, the energy-saving central control system 2 will switch to utilize the retail electricity, while the electrical energy storage device 11 continues to store electricity during off-peak hours. The power monitoring unit 204 of the control module 20 can monitor the electrical energy storage device 11 and the usage of electricity of electrical appliances which are electrically connected thereto. When the amount of stored power in the electrical energy storage device 11 is less than 20%, the electrical appliance is switched to use retail electricity in order to avoid depletion of stored power in the electrical energy storage device 11. When an unexpected condition occurs (such as power outage), the electrical energy storage device 11 will provide the remaining stored power from off-peak hours to crucial electrical appliances (such as the energy-saving lighting device 3). With the power input port 30 of the energy-saving lighting device 3 electrically connected to the lighting unit 200 of the control module 20, the energy-saving lighting device 3 can be turned on and off merely by the lighting unit 200. After the lighting unit 200 is turned on, the power monitoring unit 204 simultaneously monitors the energy consumption condition of the energy-saving lighting device 3. When the power monitoring unit 204 detects that the energy-saving lighting device 3 is damaged and consumes electricity, the power monitoring unit 204 will trigger the warning module 23 to produce warning signals informing the administrator and the user or to send warning signals through the cloud transmission module 22 to user's smartphone type of communication devices or multimedia equipments informing the administrator and the user to maintain the energy-saving lighting device 3. Besides, the power input port of the energy-saving lighting device 3 is electrically connected to the lighting unit 200 of the energy-saving central control system 2, maintenance or repair only needs to be done on the lighting unit 200.

In addition, when the energy-saving equipment 1 is installed in the office, using the management module 21, the time of electricity available and the output amount of electricity can be set with various time intervals, for example, normal mode, overtime mode, early shift mode, and late shift mode. The energy-saving equipment 1 can be electrically coupled with the access control system. When users use the access cards to open the door, the electrical energy storage device 11 begins to provide power needed by relevant electrical appliances. When users use the access cards to close the door or the time of electricity available ends, the electrical energy storage device 11 stops supplying electricity to avoid consumption of electricity after the user's departure from the office. In addition, when it is time to submit the electricity payment, the management module 21 issues a billing message about the amount of electricity cost, transmitted through the cloud transmission module 22, to the user's smartphone type of communication devices. Using the money transaction module 24 and sensing devices, the payment transaction can be completed.

In summary, the energy-saving central control system and energy-saving lighting device comprised thereof of the invention have the following advantages:

1. The energy-saving central control system and energy-saving lighting device comprised thereof of the invention store electricity during off-peak hours through the electrical energy storage device and provides stored electricity for consumption during peak hours in order to reduce the cost effectively;

2. Having the energy-saving central control system and energy-saving lighting device comprised thereof of the invention, when the user uses the electrical appliances during off-peak hours, the energy-saving central control system will switch to utilize the retail electricity, while the electrical energy storage device continues to store electricity during off-peak hours;

3. Through the power monitoring unit, the energy-saving central control system and energy-saving lighting device comprised thereof of the invention can monitor whether the electrical appliance is damaged or is consuming electricity while not being in use, and trigger the warning module to send warning signals to users once the condition is detected;

4. the energy-saving central control system and energy-saving lighting device comprised thereof of the invention allow the administrator conveniently to assist users in managing the energy-saving equipment, or make the electricity payment process more convenient while being coupled with the money transaction module; and

5. In regard to the energy-saving central control system and energy-saving lighting device comprised thereof of the invention, since the power input ports of the energy-saving lighting devices are electrically connected to the lighting unit, the lighting unit can control the on and off operations of energy-saving lighting devices, in order to achieve the goal of having a control end to manage the on and off operations of a plurality of lighting devices.

While the invention has been described in terms of preferred embodiments, those skilled in the art will recognize that the invention can be practiced with modifications within the spirit and scope of the appended claims.

What is claimed is:

1. An energy-saving central control system functioning within a control equipment electrically connected to an electrical energy storage device, comprising:
a control module;
a management module;
a cloud transmission module; and
a warning module electrically connected to the cloud transmission module;
wherein the control module comprises a lighting unit, an air conditioning unit, an appliance unit, a water heating unit, and a power monitoring unit electrically connected to electrical appliances; and
wherein the power monitoring unit is electrically connected to the lighting unit, the air conditioning unit, the appliance unit, and the water heating unit in order to monitor the usage condition of the control equipment, the electrical energy storage device, and the electrical appliances.

2. The energy-saving central control system of claim 1, wherein the electrical energy storage device stores power produced from retail electricity and electricity generated by renewable energy sources.

3. The energy-saving central control system of claim 2, wherein the electrical energy storage device mainly stores power produced from retail electricity during off-peak hours.

4. The energy-saving central control system of claim 1, wherein the management module is for the management of the input and output amount of electricity, management of the input or output time of electricity, and the monetary value of electricity output.

5. The energy-saving central control system of claim 1, wherein when the electrical appliance is damaged, consumes electricity during the time of not being used, or has a monetary value of consumed electricity exceeding a specified range, the power monitoring unit then instantly triggers the warning module to produce warning signals or to issue warning signals to be transmitted through the cloud transmission module.

6. The energy-saving central control system of claim 5, wherein the cloud transmission module can be connected to smartphone type of communication devices or multimedia devices.

7. The energy-saving central control system of claim 1, wherein the energy-saving central control system further includes a money transaction module whereas the money transaction module has a payment mechanism to transmit the payment message through the cloud transmission module to the user's smartphone type of communication device or multimedia device, allowing the user to submit payments through the money transaction module.

8. The energy-saving central control system claimed of claim 1, wherein the money transaction module further includes a leasing unit whereas the leasing unit is electrically connected to the energy-saving central control system for the convenience of recording statistical data of leasing cost when the energy-saving central control system is leased to users.

9. The energy-saving central control system claimed of claim 7, wherein the money transaction module further includes a leasing unit whereas the leasing unit is electrically connected to the energy-saving central control system for the convenience of recording statistical data of leasing cost when the energy-saving central control system is leased to users.

10. An energy-saving lighting device comprised of the energy-saving central control system of claim 1, wherein the energy-saving lighting device is equipped with a power input port electrically connected to the lighting unit, which provides 12 volts to 60 volts of electricity.
